(19) United States
(12) Patent Application Publication
(10) Pub. No.: US 2025/0113937 A1
(43) Pub. Date: Apr. 10, 2025

(54) JUICE PRESS

(71) Applicant: Design Bunker, Inc., Seattle, WA (US)

(72) Inventors: Joshua STEWART, Edmonds, WA (US); David HOLCOMB, Seattle, WA (US)

(21) Appl. No.: 18/887,475

(22) Filed: Sep. 17, 2024

Related U.S. Application Data
(60) Provisional application No. 63/588,553, filed on Oct. 6, 2023.

(51) Int. Cl. A47J 19/02; A47J 19/00

(52) U.S. Cl. CPC A47J 19/02; A47J 19/005

(57) ABSTRACT

A juice press includes a lower handle with a cup that receives a food product to be juiced, such as half of a citrus fruit. The lower handle is rotatably coupled to an upper handle that is manipulatable between an open position and a closed position. A press pivot is rotatably coupled to the lower handle and to the upper handle and includes a press plate. A linkage is rotatably coupled between the upper handle and the press plate of the press pivot. Force applied to the upper handle is concentrated to a center of the press pivot and thus a center of the food product via the linkage and press plate to improve efficiency and effectiveness of juicing the food product.

### BACKGROUND

### Technical Field

The present disclosure is generally directed to a juice press and more particularly, but not exclusively, to a citrus press.

### Description of the Related Art

A common type of juice press is a citrus press, which typically includes a cup to receive a piece of fruit, such as a lemon or a lime, and a lever arm rotatably coupled to the cup that is manipulated by a user to apply force to the fruit in the cup to squeeze juice out of the fruit. The citrus press can also be used to squeeze other types of fruit. Known citrus presses have a number of deficiencies. For example, typical citrus presses include a hinge at one outermost end of the lever arm where the lever arm interfaces with an outer edge of the cup, which concentrates significant stress and strain to this area of the press and increases the likelihood of the press breaking at this location. In addition, known citrus presses rely on the lever arm to apply force to the fruit, which can result in the lever arm bending or breaking over time, while also minimizing the amount of force applied directly to the fruit.

As a result, it would be beneficial to have a juice press that overcomes these and other deficiencies and drawbacks with known solutions.

### BRIEF SUMMARY

The present disclosure is generally directed to a juice press such as a citrus press. The juice press includes a lower handle with a cup for receiving a piece of food to be juiced, such as half of a lemon or a lime in some non-limiting examples. An upper handle is rotatably coupled to the lower handle proximate the cup of the lower handle. A press pivot is rotatably coupled to both the lower handle and the upper handle. The press pivot has a press plate extending from a concave portion of the press pivot. A linkage is rotatably coupled to the press plate and the upper handle. The user places a piece of food to be juiced in the cup of the lower handle and applies force on the upper handle to juice the food. The force on the upper handle is distributed to the press pivot via the linkage and the press plate with the linkage generally being positioned at a center of the press pivot to concentrate force on the center of the food product and improve the efficiency and effectiveness of the juicing process. Such an arrangement also relieves stress and strain on the connections between the handles and other components as well as on the upper handle to avoid mechanical failure at various locations in the press and improve the reliability.

Additional features and advantages of the concepts of the disclosure are explained in more detail below with reference to the accompanying figures.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The figures do not describe every aspect of the teachings disclosed herein and do not limit the scope of the claims.

FIG. 1A and FIG. 1B are isometric views of an implementation of a juice press according to the present disclosure in a closed position and an open position, respectively.

FIGS. 2A-2C are cross-sectional views of the juice press of FIG. 1A along line A-A in FIG. 1A illustrating sequential steps in a pressing operation of the juice press from the open position to the closed position.

FIG. 3 is a cross-sectional view of the juice press along line B-B in FIG. 1B.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide juice press devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

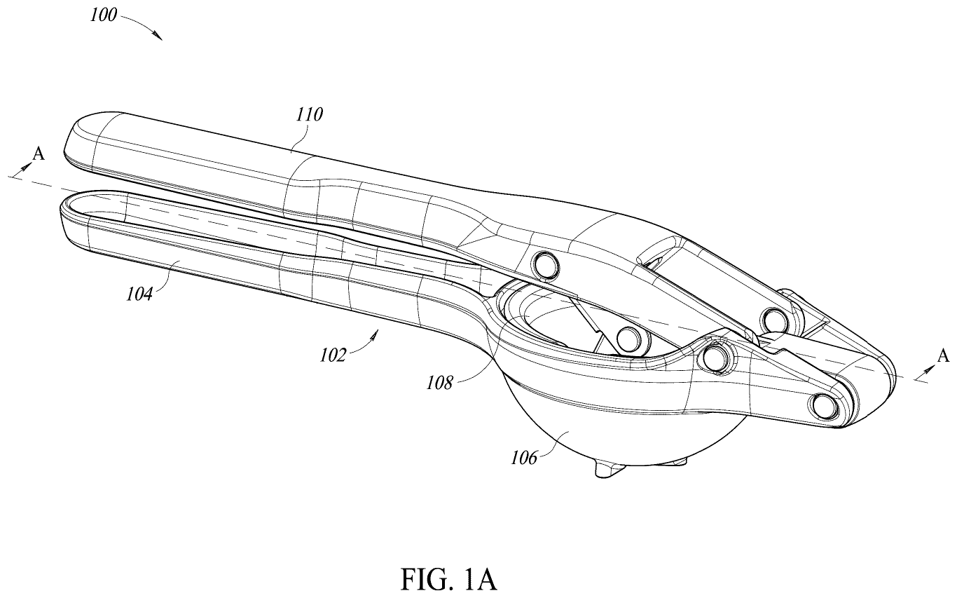

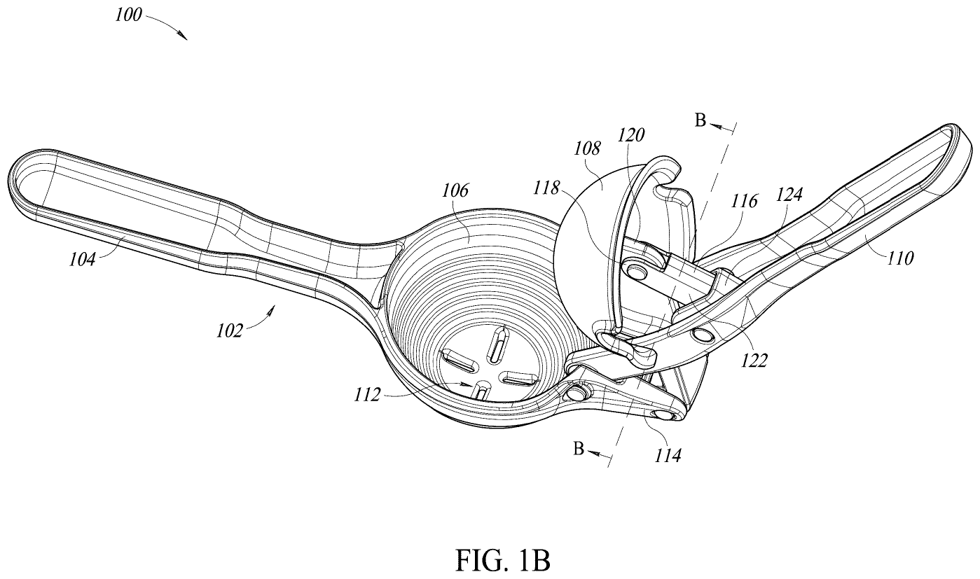

FIG. 1A and FIG. 1B are isometric views of a juice press 100 in a closed position and an open position, respectively. In an implementation, the juice press 100 is a citrus press and the closed position and open positions are outer limits on a range of travel of the juice press 100 meaning that the closed position is a fully closed position, and the open position is a fully open position. Beginning with FIG. 1A, the juice press 100 includes a lower or first handle 102 with a handle portion 104 at one end of the handle 102 and a cup 106 at an opposite end of the lower handle 102. In other words, the lower handle 102 includes the handle portion 104 leading into and terminating in the cup 106. The cup 106 is structured to receive a piece of food to be juiced, such as a lemon or lime in some non-limiting examples, as further explained herein. The juice press 100 further includes a press pivot 108 and an upper or second handle 110 rotatably coupled to each other and the lower handle 102 that will be described in more detail elsewhere. In the closed position illustrated in FIG. 1A, the press pivot 108 is received at least partially or entirely in the cup 106 of the lower handle 102, meaning the press pivot 108 is nested with the cup 106. The upper handle 110 is positioned vertically above the lower handle 102 and the press pivot 108 and in close proximity to the lower handle and the press pivot 108 to reduce the space occupied by the citrus press 100 in the closed position.

FIG. 1B illustrates the juice press 100 in the open position and provides more details of the features of the juice press 100. The cup 106 is a hollow concavity or vessel that is structured to receive a food to be juiced and may preferably have a spherical or at least partially spherical shape designed to receive half of a citrus fruit. The cup 106 includes openings 112 at the bottom of the cup 106 to allow juice to flow out of the press 100 after squeezing the food product. The press pivot 108 preferably has a convex shape that corresponds to a shape of the cup 106. The press pivot 108 may be solid piece of material that acts directly on the food product to be pressed to assist with squeezing juice out of the food product and avoid fluid flow through the press pivot 108. The lower handle 102 may include coupling arms 114 extending from the cup 106 in a direction away from the handle portion 104 of the lower handle 102. In an implementation, the coupling arms 114 define an outermost edge of the lower handle 102 opposite the handle portion 104. The coupling arms 114 receive a pin or other fastener to rotatably couple the press pivot 108 to the lower handle 102. The upper handle 110 is rotatably coupled to the lower handle 102 by a further pin or other fastener at the cup 106, or at a location closer to the cup 106 than the press pivot 108.

The upper handle 110 is coupled to the press pivot 108 by a linkage 116 and further pins or other fasteners. A first outer end 118 of the linkage 116 is attached to a ridge or press plate 120 of the press pivot 108. The ridge or press plate 120 is a projection extending from a cavity of the press pivot 108 in a direction away from the cup 106. The ridge 120 may have a trapezoidal or other selected shape and assists with transferring force to the press pivot 108 from the upper handle 110 while also providing mechanical support for the linkage 116, as further described herein. A second outer end 122 of the linkage 116 opposite to the first outer end 118 is received in a sleeve or flange 124 extending from an inner surface of the upper handle 110 to provide support for the linkage 116 and to limit rotational motion of the press pivot 108 and/or the upper handle 110 beyond the open position shown in FIG. 1B.

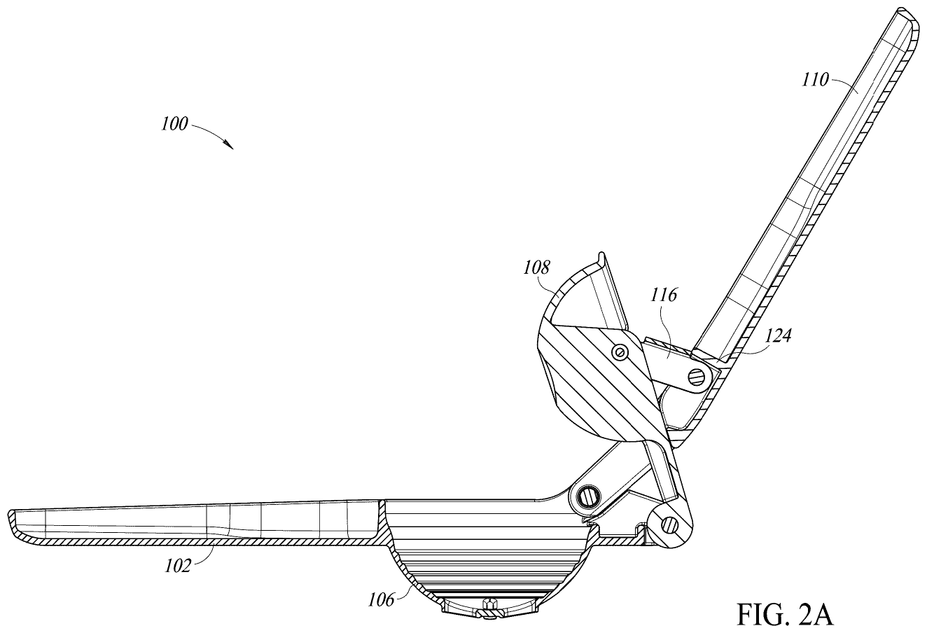

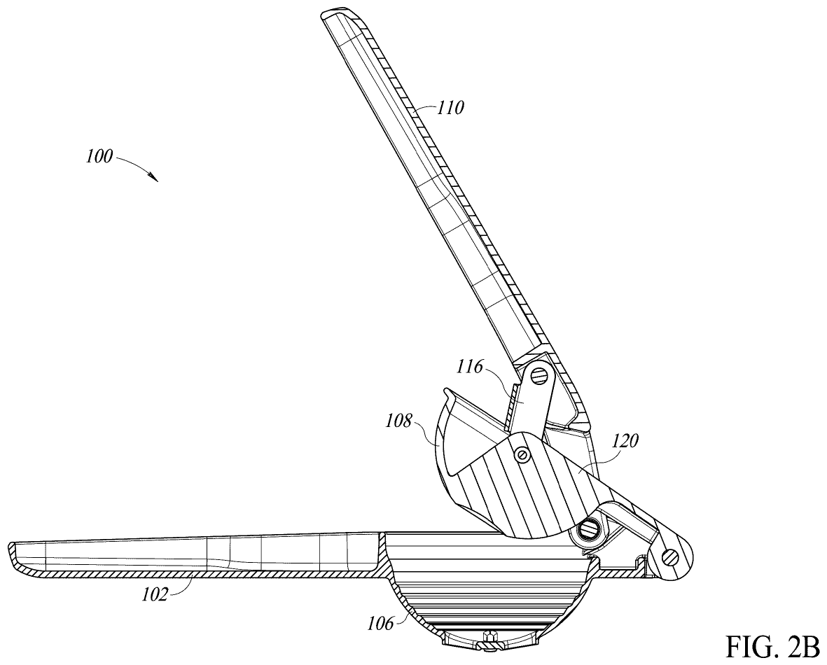

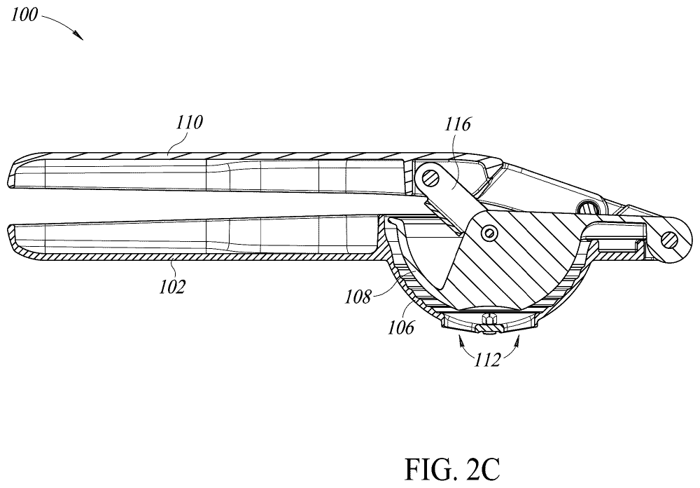

FIGS. 2A-2C are cross-sectional views of the juice press 100 along line A-A in FIG. 1A illustrating sequential steps in a pressing operation of the juice press from the open position to the closed position. Beginning with FIG. 2A, the juice press 100 is manipulated to the open position by a user lifting the upper handle 110 and rotating the same relative to the lower handle 102. The movement of the upper handle 110 also results in rotation of the press pivot 108 via the linkage 116. In an implementation, the linkage 116 is prevented from further rotation beyond the open position by the sleeve 124 (i.e., by contacting the sleeve 124), which in turn, limits rotation of the upper handle 110 beyond the open position. As such, the sleeve 124 may provide not only mechanical support for the linkage 116 but may also serve as a limit on the range of rotational travel of the upper handle 110 and the press pivot 108. In the open position, the upper handle 110 is rotated more than 90 degrees away from the lower handle 102, but preferably less than 180 degrees and in some implementations, less than 135 degrees away from the lower handle 102. The press pivot 108 may rotate less than 90 degrees away from the lower handle 102 and in some implementations, may be at an angle between 60 degrees and 90 degrees relative to the lower handle 102 in the open position including all intervening and limit values. The rotation of the upper handle 110 and the press pivot 108 provides access to the cup 106 in the open position, meaning that the cup 106 is open and able to receive a food product to be pressed, as shown in FIG. 2A. Once the press 100 is in the open position, a food product to be juiced, such as a half piece of citrus fruit may be received in the cup 106 cut side down. During operation, the cup 106 and press pivot 108 will attempt to turn the citrus fruit inside out from the squeezing operation, rendering the highest yield of juice and avoiding spraying juice toward the user. In sum, the half piece of citrus fruit is placed with the flat side or cut side facing downward into the cup 106 and the operation of the press 100 applies significant force to the rind to maximize juice yield, as described herein. After juicing, the juiced lemon rind fits the cup 108.

Turning to FIG. 2B, illustrated therein is the juice press 100 in an intermediate position between the open position and the closed position (i.e., midway through a path of travel of the juice press 100). Once the food product is placed in the cup 106, the user begins to rotate the upper handle 110 toward the lower handle 102. The rotation of the upper handle 110 rotates the press pivot 108 toward the cup 106 via the linkage 116 until the press pivot 108 contacts the food product to be juiced. The press pivot 108 follows a radial path between the open and closed positions, but a rate of motion of the press pivot 108 along the radial path may be eccentric or vary throughout the rotational path. The linkage 116 rotates the press pivot 108 faster through the top of the range (i.e., from the open position to at least the intermediate position) than from the intermediate position to the closed position. At the top of the range, the press pivot 108 is closing the open space between the press pivot 108 and the food product to be juiced. At the bottom of the range, the press pivot 108 is in contact with the food product and actively juicing the food product. The rotation or angular position of the linkage 116 as well as the pivot locations (i.e., rotational coupling locations between the components described herein) enable such functionality of the press pivot 108 by applying relatively higher leverage, but a slower rate of travel at the bottom of the range of the press pivot 108 and relatively lower leverage and a higher rate of travel at the top of the range of the press pivot 108.

The press plate or ridge 120 in the press pivot 108 enables the linkage 116 to be coupled to the press pivot 108 at a center of the press pivot 108. The “center” of the press pivot 108 in this context only means a center of a horizontal plane that includes an uppermost lip or edge of the press pivot 108 when the press pivot 108 is in the closed position or is otherwise at rest on a flat and horizontal surface. The force concentrated at the center of the press pivot 108 is then distributed throughout the press plate 108 and into the food product via the press plate 120. As a result, the location of the connection with the linkage 116 at the center of the press pivot 108 applies force from the upper handle 110 to a center of the food product. In prior juice presses, the force is applied to the food product by the lever arm and is therefore distributed linearly along the food product by a path defined by the lever arm, resulting in efficient application of force and additional manual input by the user. However, in the juice press 100, the force from the upper handle 110 is concentrated in a center of the press pivot 108 and is therefore applied more directly to the food product to result in more efficient and effective juicing of the food product. Still further, the concentration of the force to the center of the press pivot 108 via linkage, in combination with support from the press plate 120 and the sleeve 124, relieves stress and strain from the connection between the upper handle 110 and the lower handle 102 and from the upper handle 110 and the linkage 116, as well as from the upper handle 110 itself, to reduce the likelihood of a mechanical failure at these locations.

The user continues to rotate the upper arm 110 relative to the lower arm 102 until the juice press reaches the closed position shown in FIG. 2C. In the closed position, the press pivot 108 is nested in the cup 106 of the lower handle 102 and the juiced food product fills the cup 106 such that the upper handle 110 is spaced from, but closely approximates the lower handle 102. Absent the juiced food product in the cup 106, the forward end of the press pivot 108 rests on the coupling arms 114 of the lower handle 102 to maintain a spaced relationship between the bottom surface of the press pivot 108 and the cup 106 and a gap between the handles 102, 110 to avoid scratches to the press 100, which may have a reflective or shiny finish that is aesthetically desirable. In this position, the food product is squeezed and fills the space between the cup 106 and the press plate 108, with juice from the food product flowing out from a bottom of the press 100 via holes 112 best shown in FIG. 1B. The process can then be repeated by manipulating the press 100 to the open position, removing the juiced food product, and adding a new food product to the cup 106. Related methods to the above steps are also contemplated herein.

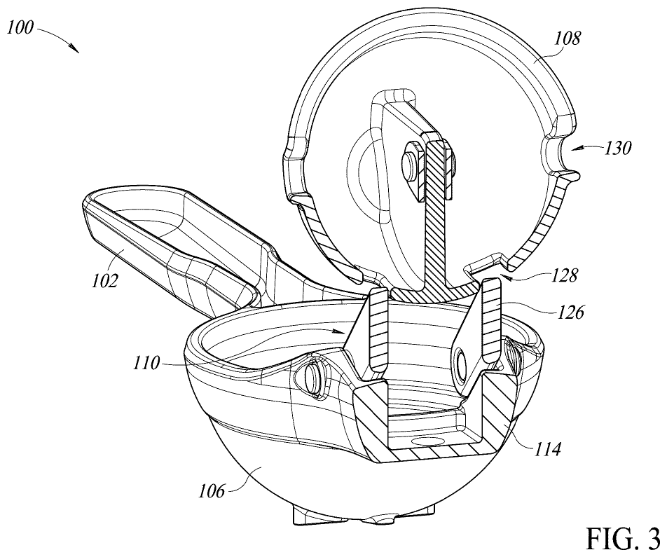

FIG. 3 is a cross-sectional view of the juice press 100 along line B-B in FIG. 1B. FIG. 3 provides more detail of a base of the coupling arms 114 where the coupling arms 114 interface with the cup 106 as well as of the upper handle 110 and the press pivot 108. The upper handle 110 may terminate in a pair of spaced apart extensions 126 that are coupled to the cup 106. To facilitate the rotational motion of the upper handle 110 and the press pivot 108, the press pivot 108 may include corresponding apertures or cutouts 128 in a front portion of the press pivot 108. The extensions 126 of the upper handle 110 move along the cutouts 128 through the motion of the upper handle 110 to prevent interference between the handle 110 and the press pivot 108. FIG. 3 also provides more detail of the press plate 120 of the press pivot 108. The press plate 120 may preferably be a solid, continuous piece of material although the plate 120 could also be hollow. As described above and as best shown in FIGS. 2A-2C, the press plate 120 may have a generally trapezoidal shape with one side of the press plate 120 generally tapering a center of the press pivot 108 toward a rear (i.e., toward handle portion 104 of lower handle 102) of the press 100 while being joined to the cup 106 on its bottom and other sides. The press plate 120 may have a top surface that is generally aligned with a top surface of the press pivot 108. Such a structure and shape of the press plate 120 assists with providing support for the linkage 116 and the press pivot 108, although variations of the structure and shape of the press plate 120 are contemplated herein. In an implementation, the press plate 120 further adds rigidity to the press pivot 108 to prevent the press pivot 108 from collapsing, bending, or otherwise failing under the force applied to the upper handle 110 during the pressing operation described herein. The press pivot 108 may further include at least one or a pair of opposing openings 130 on lateral sides of the press pivot 108 to accommodate a tooling slide for accessing the press plate 120 and forming holes therein for the coupling between the press plate 120 and the linkage 116 at a center of the plate 120 and/or press pivot 108.

In one or more implementations, a device may be summarized as including: a lower handle including a cup structured to receive a food product; an upper handle rotatably coupled to the lower handle; and a press pivot rotatably coupled to the lower handle and to the upper handle, wherein the press pivot is configured to apply a concentrated force to a center of the food product to juice the food product.

In an implementation, the device further includes a linkage rotatably coupled to the press pivot and the upper handle, wherein the linkage is configured to distribute force from the upper handle to the press pivot.

In an implementation, the press pivot includes a press plate, the linkage rotatably coupled to the press plate proximate a center of the press pivot.

In an implementation, the cup includes at least one opening at a bottom of the cup.

In an implementation, the upper handle includes extensions to facilitate coupling of the upper handle to the lower handle, and the press pivot includes at least one cutout to avoid interference with the extensions of the upper handle over a range of travel of the upper handle.

In an implementation, the press pivot includes a press plate.

In an implementation, the upper handle is coupled to the lower handle closer to the cup than the press pivot.

In an implementation, the upper handle is positioned at an angle to the lower handle in an open position that is between 90 degrees and 135 degrees.

In an implementation, the press pivot is positioned at an angle to the lower handle in the open position of the upper handle that is between 45 degrees and 90 degrees.

In an implementation, the press pivot is nested in the cup of the lower handle in a closed position of the press pivot.

In one or more implementations, a device may be summarized as including: a lower handle including a cup; an upper handle rotatably coupled to the lower handle and manipulatable between a closed position and an open position; a press pivot rotatably coupled to the lower handle and to the upper handle, wherein the press pivot includes a press plate; and a linkage rotatably coupled between the upper handle the press plate of the press pivot.

In an implementation, the press plate extends away from the cup of the lower handle and is configured to support the press pivot and distribute force from the upper handle to the press pivot.

In an implementation, the press plate is a solid, continuous piece of material.

In an implementation, the linkage is coupled to a center of the press plate, the linkage configured to concentrate a force from the upper handle to a central area of the press pivot.

In an implementation, the press pivot includes one or more cutouts to avoid interference with the upper handle over a range of travel of the upper handle between the open position and the closed position.

In an implementation, the upper handle includes a sleeve configured to receive and support the linkage.

In an implementation, the upper handle is coupled to the lower handle proximate the cup and the press pivot is coupled to the lower handle at a location spaced from the cup.

In an implementation, the upper handle is coupled to the cup and the lower handle includes coupling arms extending from the cup and coupled to the press pivot.

In an implementation, the upper handle is positioned at an angle to the lower handle in the open position of the upper handle that is between 90 degrees and 135 degrees and the press pivot is positioned at an angle to the lower handle in the open position of the upper handle that is between 45 degrees and 90 degrees.

In an implementation, the press pivot is nested in the cup of the lower handle in a closed position of the press pivot.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the juice press context, and are not limited to the example systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with induction heating devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, glass, wood, and the like, cither alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims priority to U.S. Provisional Patent Application No. 63/588,553 filed on Oct. 6, 2023, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A device, comprising:
a lower handle including a cup structured to receive a food product;
an upper handle rotatably coupled to the lower handle; and
a press pivot rotatably coupled to the lower handle and to the upper handle, wherein the press pivot is configured to apply a concentrated force to a center of the food product to juice the food product.

2. The device of claim 1, further comprising:
a linkage rotatably coupled to the press pivot and the upper handle, wherein the linkage is configured to distribute force from the upper handle to the press pivot.

3. The device of claim 2, wherein the press pivot includes a press plate, the linkage rotatably coupled to the press plate proximate a center of the press pivot.

4. The device of claim 1, wherein the cup includes at least one opening at a bottom of the cup.

5. The device of claim 1, wherein the upper handle includes extensions to facilitate coupling of the upper handle to the lower handle, and the press pivot includes at least one cutout to avoid interference with the extensions of the upper handle over a range of travel of the upper handle.

6. The device of claim 1, wherein the press pivot includes a press plate.

7. The device of claim 1, wherein the upper handle is coupled to the lower handle closer to the cup than the press pivot.

8. The device of claim 1, wherein the upper handle is positioned at an angle to the lower handle in an open position that is between 90 degrees and 135 degrees.

9. The device of claim 8, wherein the press pivot is positioned at an angle to the lower handle in the open position of the upper handle that is between 45 degrees and 90 degrees.

10. The device of claim 1, wherein the press pivot is nested in the cup of the lower handle in a closed position of the press pivot.

11. A device, comprising:
a lower handle including a cup;
an upper handle rotatably coupled to the lower handle and manipulatable between a closed position and an open position;
a press pivot rotatably coupled to the lower handle and to the upper handle, wherein the press pivot includes a press plate; and
a linkage rotatably coupled between the upper handle the press plate of the press pivot.

12. The device of claim 11, wherein the press plate extends away from the cup of the lower handle and is configured to support the press pivot and distribute force from the upper handle to the press pivot.

13. The device of claim 11, wherein the press plate is a solid, continuous piece of material.

14. The device of claim 11, wherein the linkage is coupled to a center of the press plate, the linkage configured to concentrate a force from the upper handle to a central area of the press pivot.

15. The device of claim 11, wherein the press pivot includes one or more cutouts to avoid interference with the upper handle over a range of travel of the upper handle between the open position and the closed position.

16. The device of claim 11, wherein the upper handle includes a sleeve configured to receive and support the linkage.

17. The device of claim 11, wherein the upper handle is coupled to the lower handle proximate the cup and the press pivot is coupled to the lower handle at a location spaced from the cup.

18. The device of claim 17, wherein the upper handle is coupled to the cup and the lower handle includes coupling arms extending from the cup and coupled to the press pivot.

19. The device of claim 11, wherein the upper handle is positioned at an angle to the lower handle in the open position of the upper handle that is between 90 degrees and 135 degrees and the press pivot is positioned at an angle to the lower handle in the open position of the upper handle that is between 45 degrees and 90 degrees.

20. The device of claim 11, wherein the press pivot is nested in the cup of the lower handle in a closed position of the press pivot.
